(19) United States
(12) Patent Application Publication
(10) Pub. No.: US 2026/0188247 A1
(43) Pub. Date: Jul. 2, 2026

(54) ELECTRONIC DEVICE

(71) Applicant: Samsung Display Co., Ltd., Yongin-si (KR)

(72) Inventor: SEHYUK PARK, Yongin-si (KR)

(21) Appl. No.: 19/344,203

(22) Filed: Sep. 29, 2025

(30) Foreign Application Priority Data
Dec. 30, 2024 (KR) 10-2024-0201141

(51) Int. Cl. G09G 3/3266; G09G 3/3275

(52) U.S. Cl. CPC G09G 3/3266; G09G 3/3275; G09G 2310/0221; G09G 2310/04; G09G 2310/08; G09G 2320/0613; G09G 2330/021; G09G 2340/0435; G09G 2354/00

(57) ABSTRACT

An electronic device includes a processor and a display module that displays an image. The display module includes a display panel including first scan lines arranged in the first display area, second scan lines arranged in the second display area, and switching transistors that electrically connects the first scan lines and the second scan lines in response to a switching signal, a first scan driving circuit that outputs first scan signals to the first scan lines, a second scan driving circuit that outputs second scan signals to the second scan lines, a data driving circuit that outputs data signals to the display module, and a driving controller outputs the switching signal such that the first scan lines and the second scan lines are electrically separated when the mode signal indicates an artificial intelligence mode for displaying an artificial intelligence image.

### CROSS-REFERENCE TO RELATED APPLICATION

The present application claims priority to and the benefit of Korean Patent Application No. 10-2024-0201141, filed on December 30, 2024, in the Korean Intellectual Property Office, the entire disclosure of which is incorporated herein by reference.

### BACKGROUND

Aspects of some embodiments of the present disclosure described herein relate to an electronic device displaying images.

Electronic devices such as televisions, mobile phones, tablet computers, navigation systems, and game consoles generate images and display the generated images to users through display screens.

The electronic device includes a plurality of pixels and a plurality of driving circuits that control an image to be displayed on the plurality of pixels. Each of the plurality of pixels includes a light emitting element and transistors that control the light emitting element.

The above information disclosed in this Background section is only for enhancement of understanding of the background and therefore the information discussed in this Background section does not necessarily constitute prior art.

### SUMMARY

Embodiments of the present disclosure provide an electronic device capable of relatively reducing power consumption.

According to some embodiments of the present disclosure, an electronic device includes a processor that outputs an image signal, a control signal, and a mode signal, and a display module that displays an image. The display module includes a display panel divided into a first display area and a second display area and including first scan lines arranged in the first display area, second scan lines arranged in the second display area, and switching transistors that electrically connects the first scan lines and the second scan lines in response to a switching signal, a first scan driving circuit that outputs first scan signals to the first scan lines, a second scan driving circuit that outputs second scan signals to the second scan lines, a data driving circuit that outputs data signals to the display module, and a driving controller that controls the first scan driving circuit, the second scan driving circuit, and the data driving circuit in response to the image signal, the control signal, and the mode signal, and the driving controller outputs the switching signal such that the first scan lines and the second scan lines are electrically separated when the mode signal indicates an artificial intelligence mode for displaying an artificial intelligence image.

According to some embodiments, each of the first scan lines may extend in a first direction from the first scan driving circuit, each of the second scan lines may extend in a second direction different from the first direction from the second scan driving circuit, and the first display area and the second display area may be sequentially arranged in the first direction.

According to some embodiments, during the artificial intelligence mode, the first display area may be driven at a first frequency, and the second display area may be driven at a second frequency different from the first frequency.

According to some embodiments, during the artificial intelligence mode, the first scan driving circuit may output the first scan signals having the first frequency, and the second scan driving circuit may output the second scan signals having the second frequency.

According to some embodiments, the artificial intelligence image may include a still image, and the second frequency may be lower than the first frequency.

According to some embodiments, the display panel may further include first data lines arranged in the first display area and second data lines arranged in the second display area.

According to some embodiments, during a first frame of the artificial intelligence mode, the data driving circuit may output the data signals to the first data lines and the second data lines, and during a second frame of the artificial intelligence mode, the data driving circuit may output the data signals to the first data lines and may not output the data signals to the second data lines.

According to some embodiments, the driving controller may output the switching signal such that the first scan lines and the second scan lines are electrically connected when the mode signal indicates a basic mode different from the artificial intelligence mode.

According to some embodiments, during the basic mode, both the first display area and the second display area may be driven at the first frequency.

According to some embodiments, the processor may output the image signal corresponding to the first display area and the second display area during a first frame of the artificial intelligence mode, and the processor may output the image signal corresponding to the first display area during a second frame of the artificial intelligence mode.

According to some embodiments, when the artificial intelligence mode is selected by a user, an artificial intelligence signal indicating the artificial intelligence mode may be provided to the processor, and the processor may output the mode signal in response to the artificial intelligence signal.

According to some embodiments of the present disclosure, an electronic device includes a display panel divided into a first display area and a second display area, and including first scan lines arranged in the first display area, second scan lines arranged in the second display area, and switching transistors that electrically connect the first scan lines and the second scan lines in response to a switching signal, a first scan driving circuit that outputs first scan signals to the first scan lines, a second scan driving circuit that outputs second scan signals to the second scan lines, a data driving circuit that outputs data signals to the display panel, and a driving controller that controls the first scan driving circuit, the second scan driving circuit, and the data driving circuit in response to an image signal, a control signal, and a mode signal. The driving controller outputs the switching signal such that the first scan lines and the second scan lines are electrically separated when the mode signal indicates an artificial intelligence mode for displaying an artificial intelligence image, and during the artificial intelligence mode, the first display area is driven at a first frequency, and the second display area is driven at a second frequency different from the first frequency.

According to some embodiments, each of the first scan lines may extend in a first direction from the first scan driving circuit, each of the second scan lines may extend in a second direction different from the first direction from the second scan driving circuit, and the first display area and the second display area may be sequentially arranged in the first direction.

According to some embodiments, during the artificial intelligence mode, the first scan driving circuit may output the first scan signals having the first frequency, and the second scan driving circuit may output the second scan signals having the second frequency.

According to some embodiments, the artificial intelligence image may include a still image, and the second frequency may be lower than the first frequency.

According to some embodiments, the display panel may further include first data lines arranged in the first display area and second data lines arranged in the second display area.

According to some embodiments, during a first frame of the artificial intelligence mode, the data driving circuit may output the data signals to the first data lines and the second data lines, and during a second frame of the artificial intelligence mode, the data driving circuit may output the data signals to the first data lines and may not output the data signals to the second data lines.

According to some embodiments, the driving controller may output the switching signal such that the first scan lines and the second scan lines are electrically connected when the mode signal indicates a basic mode different from the artificial intelligence mode.

According to some embodiments, during the basic mode, both the first display area and the second display area may be driven at the first frequency.

According to some embodiments, during the artificial intelligence mode, a moving image may be displayed in the first display area, and a still image may be displayed in the second display area.

### BRIEF DESCRIPTION OF THE DRAWINGS

The above and other objects and features of the present disclosure will become apparent by describing in detail embodiments thereof with reference to the accompanying drawings.

FIG. 1 is a block diagram of an electronic device according to some embodiments.

FIG. 2 is a schematic diagram of electronic devices according to some embodiments.

FIG. 3 is a plan view schematically illustrating a display module.

FIG. 4 is a block diagram of a processor and a display module, according to some embodiments of the present disclosure.

FIG. 5 is a perspective view illustrating an electronic device, according to some embodiments of the present disclosure.

FIG. 6 is a diagram illustrating an example of an image displayed on a display panel in an artificial intelligence mode.

FIG. 7 is a diagram illustrating first scan signals, second scan signals, and a switching signal in a basic mode as an example.

FIG. 8 is a diagram illustrating first scan signals, second scan signals, and a switching signal in an artificial intelligence mode as an example.

FIG. 9 is a diagram illustrating an image signal and a switching signal in the basic mode as an example.

FIG. 10 is a diagram illustrating an image signal and a switching signal in an artificial intelligence mode as an example.

FIG. 11 is a diagram illustrating a display panel according to some embodiments of the present disclosure as an example.

FIG. 12A and FIG. 12B are diagrams illustrating images displayed on a display module as an example.

### DETAILED DESCRIPTION

In the specification, when one component (or area, layer, part, or the like) is referred to as being “on”, “connected to”, or “coupled to” another component, it should be understood that the former may be directly on, connected to, or coupled to the latter, and also may be on, connected to, or coupled to the latter via a third intervening component.

Identical drawing symbols refer to identical components. Also, in drawings, the thickness, ratio, and dimension of components are exaggerated for effectiveness of description of technical contents. The term “and/or” includes one or more combinations of the associated listed items.

The terms “first”, “second”, etc. are used to describe various components, but the components are not limited by the terms. The terms are used only to differentiate one component from another component. For example, a first component may be named as a second component, and vice versa, without departing from the spirit or scope of the present disclosure. A singular form, unless otherwise stated, includes a plural form.

Also, the terms “under”, “beneath”, “on”, “above” are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Unless otherwise defined, all terms (including technical terms and scientific terms) used in this specification have the same meaning as commonly understood by those skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the present disclosure will be described with reference to accompanying drawings.

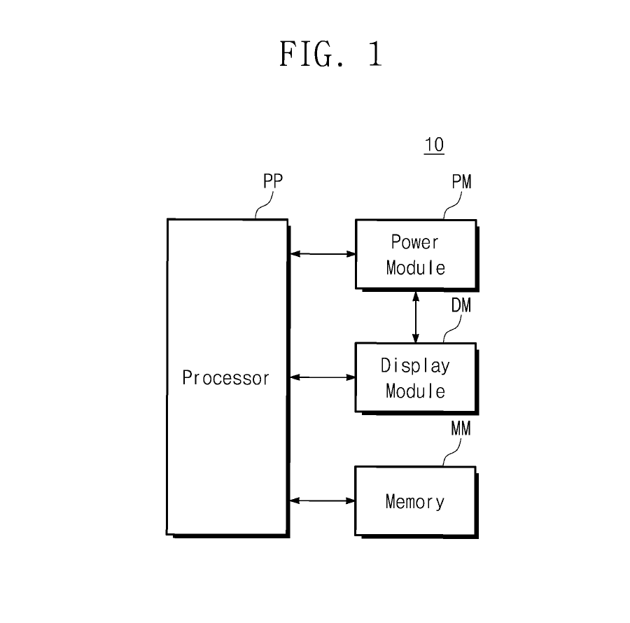

FIG. 1 is a block diagram of an electronic device 10 according to some embodiments.

Referring to FIG. 1, the electronic device 10 according to some embodiments may include a display module DM, a processor PP, a memory MM, and a power module PM.

The processor PP may include at least one of a central processing unit (CPU), an application processor (AP), a graphics processing unit (GPU), a communication processor (CP), an image signal processor (ISP), or a controller.

The memory MM may store data information necessary or desirable for operations of the processor PP or the display module DM. When the processor PP executes an application stored in the memory MM, an image data signal and/or an input control signal is transferred to the display module DM, and the display module DM may process the received signal and may output image information through a display screen.

The power module PM may include a power supply module, such as a power adapter or a battery device, and a power conversion module that converts power supplied by the power supply module to generate power required for the operation of the electronic device 10.

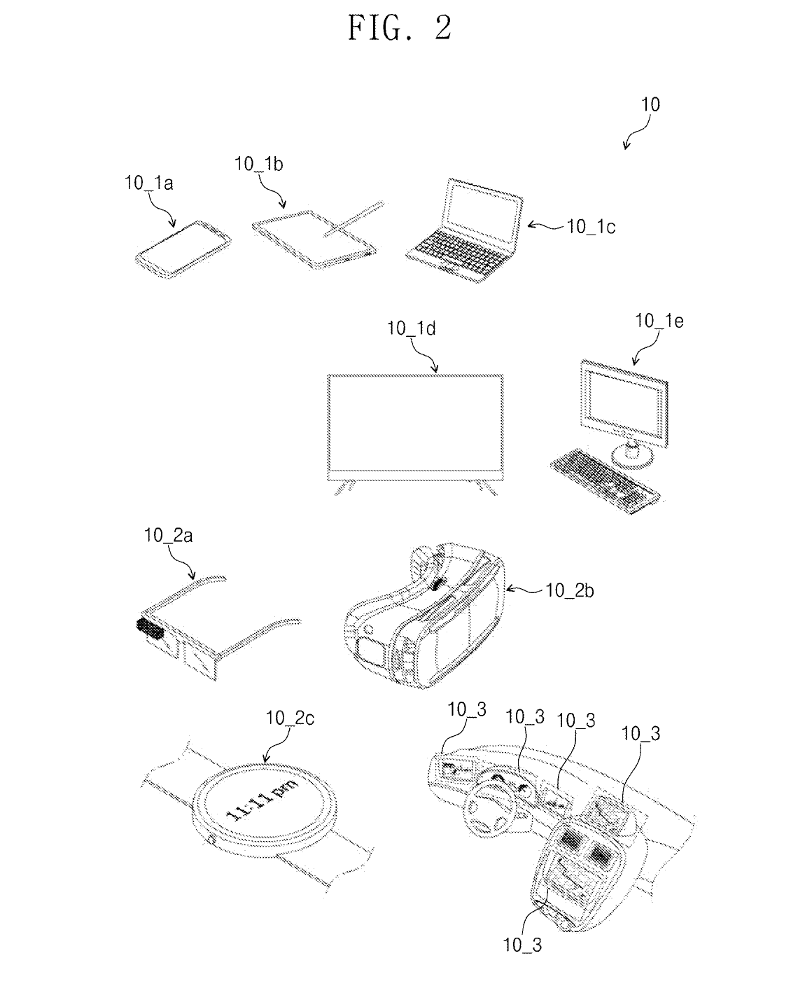

FIG. 2 is a schematic diagram of electronic devices according to various embodiments.

Referring to FIG. 2, various electronic devices according to embodiments may include not only image display electronic devices such as a smart phone 10_1a, a tablet PC 10_1b, a laptop computer 10_1c, a TV 10_1d, a desk monitor 10_1e, but also wearable electronic devices including display modules such as smart glasses 10_2a, a head-mounted display 10_2b, a smart watch 10_2c, etc., and vehicle electronic devices 10_3 including display modules such as a CID (Center Information Display) placed on an instrument panel, a center fascia, or a dashboard of a vehicle, a room mirror display, etc.

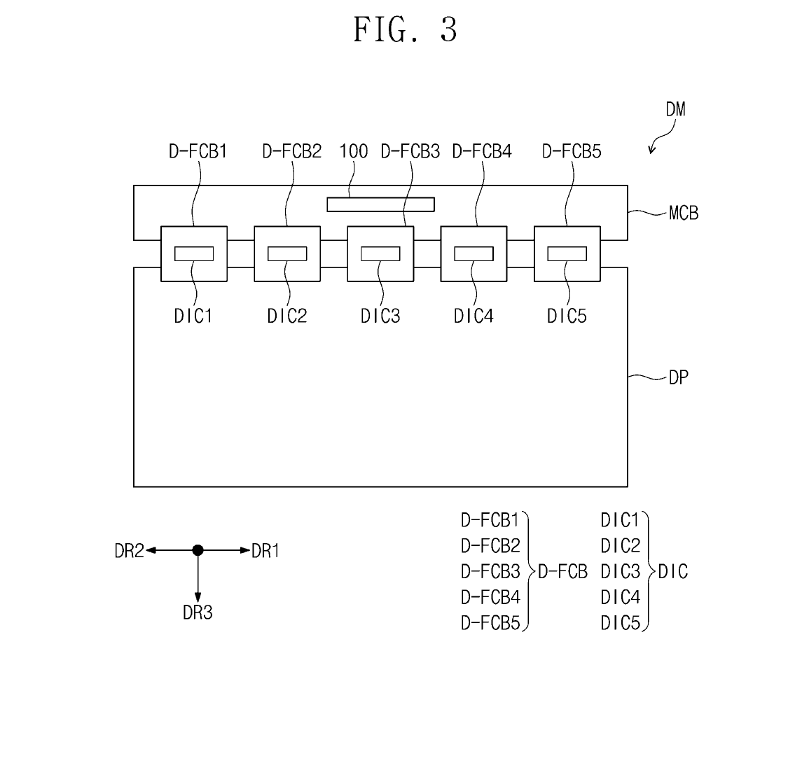

FIG. 3 is a plan view schematically illustrating further details of the display module DM.

Referring to FIG. 3, the display module DM may include a display panel DP, a main circuit board MCB, flexible circuit films D-FCB, driving circuits DIC, and a driving controller 100.

The display panel DP according to some embodiments of the present disclosure may be a light emitting display panel that displays an image.

The main circuit board MCB may be electrically connected to the display panel DP by being connected to the flexible circuit films D-FCB. The flexible circuit films D-FCB are connected to the display panel DP to electrically connect the display panel DP to the main circuit board MCB. The main circuit board MCB may further include a plurality of components. Each of the plurality of components may include a circuit part for driving the display panel DP. The driving circuits DIC may be mounted on the flexible circuit films D-FCB.

As an example of the present disclosure, the flexible circuit films D-FCB may include a first flexible circuit film D-FCB1, a second flexible circuit film D-FCB2, a third flexible circuit film D-FCB3, a fourth flexible circuit film D-FCB4, and a fifth flexible circuit film D-FCB5. The driving circuits DIC may include a first driving circuit DIC1, a second driving circuit DIC2, a third driving circuit DIC3, a fourth driving circuit DIC4, and a fifth driving circuit DIC5. The first to fifth flexible circuit films D-FCB1, D-FCB2, D-FCB3, D-FCB4, and D-FCB5 may be arranged to be spaced apart from each other in a first direction DR1. The first to fifth flexible circuit films D-FCB1, D-FCB2, D-FCB3, D-FCB4, and D-FCB5 are connected to the display panel DP to electrically connect the display panel DP to the main circuit board MCB. The first to fifth driving circuits DIC1, DIC2, DIC3, DIC4, and DIC5 may be mounted on the first to fifth flexible circuit films D-FCB1, D-FCB2, D-FCB3, D-FCB4, and D-FCB5, respectively. However, embodiments of the present disclosure are not limited thereto. For example, the display panel DP may be electrically connected to the main circuit board MCB through one flexible circuit film, and only one driving circuit may be mounted on one flexible circuit film. In addition, the display panel DP may be electrically connected to the main circuit board MCB through two or more flexible circuit films, and driving circuits may be mounted on the flexible circuit films, respectively. In addition, the first to fifth driving circuits DIC1, DIC2, DIC3, DIC4, and DIC5 may be mounted directly on the main circuit board MCB.

In the embodiments illustrated in FIG. 3, the display module DM is illustrated as including five driving circuits, that is, the first to fifth driving circuits DIC1, DIC2, DIC3, DIC4, and DIC5, but embodiments according to the present disclosure are not limited thereto. The display module DM may include one or two or more driving circuits.

The driving controller 100 may be mounted on the main circuit board MCB. The driving controller 100 may be electrically connected to the first to fifth driving circuits DIC1, DIC2, DIC3, DIC4, and DIC5 through the first to fifth flexible circuit films D-FCB1, D-FCB2, D-FCB3, D-FCB4, and D-FCB5. In addition, the driving controller 100 may be electrically connected to the display panel DP through the first to fifth flexible circuit films D-FCB1, D-FCB2, D-FCB3, D-FCB4, and D-FCB5.

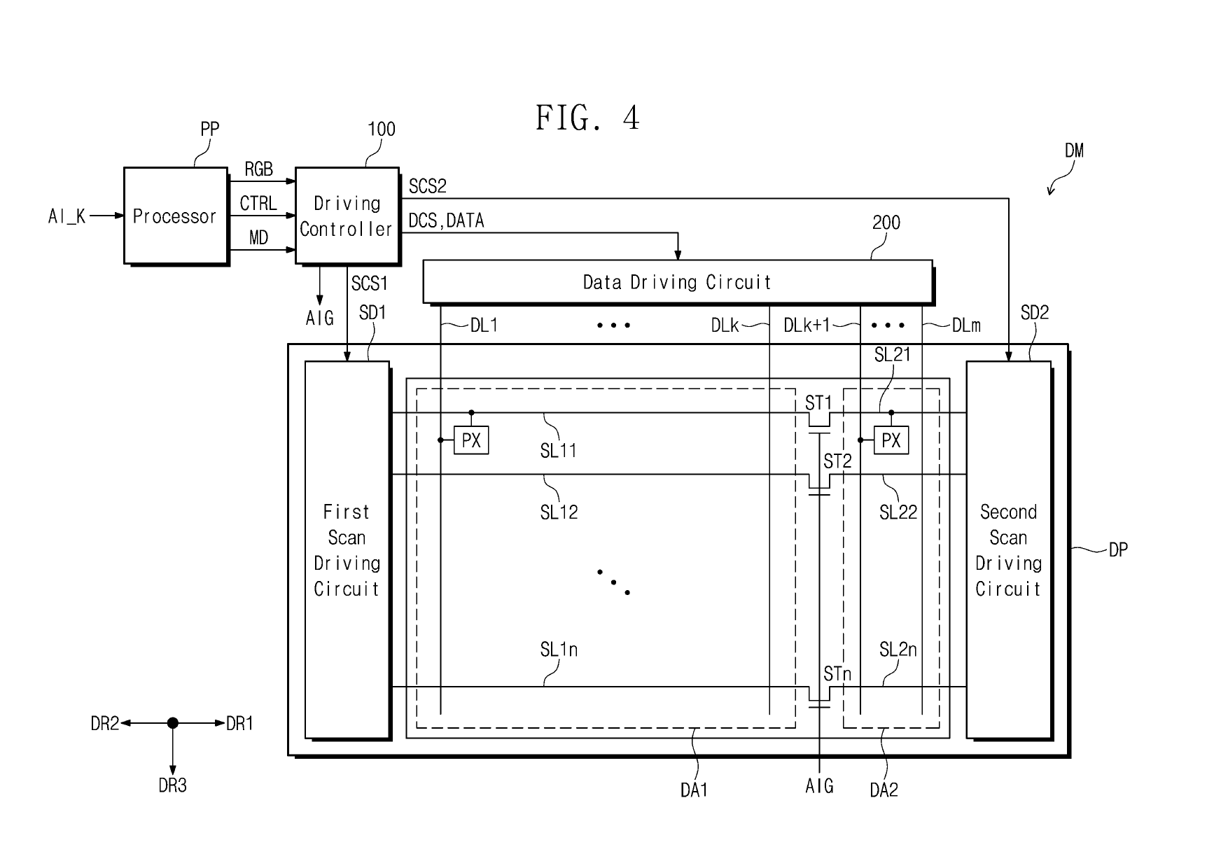

FIG. 4 is a block diagram of the processor PP and the display module DM, according to some embodiments of the present disclosure.

Referring to FIG. 4, the processor PP outputs an image signal RGB, a control signal CTRL, and a mode signal MD. The image signal RGB, the control signal CTRL, and the mode signal MD may be provided to the display module DM.

The processor PP may provide the mode signal MD indicating the basic mode or the artificial intelligence mode in response to the artificial intelligence signal AI_K to the display module DM. According to some embodiments, the control signal CTRL may include the mode signal MD.

The display module DM includes the driving controller 100, a data driving circuit 200, a first scan driving circuit SD1, a second scan driving circuit SD2, and the display panel DP.

The processor PP and the driving controller 100 of the display module DM may be connected through a communication interface such as a MIPI (Mobile Industry Processor Interface). The driving controller 100 may include a restoration circuit or a decoder that restores a signal received from the processor PP.

The driving controller 100 receives the input image signal RGB, the control signal CTRL, and the mode signal MD, which are provided from the processor PP.

The driving controller 100 generates an output image signal DATA obtained by converting the input image signal RGB into an image type suitable for the display panel DP. The driving controller 100 outputs a switching signal AIG, a first scan control signal SCS1, a second scan control signal SCS2, and a data control signal DCS.

According to some embodiments of the present disclosure, the display panel DP may be a light emitting display panel. For example, the display panel DP may be an organic light emitting display panel, an inorganic light emitting display panel, or an quantum dot light emitting display panel. A light emitting layer of the organic light emitting display panel may include an organic light emitting material. A light emitting layer of the inorganic light emitting display panel may include an inorganic light emitting material. A light emitting layer of the quantum dot light emitting display panel may include a quantum dot, a quantum rod, etc. The following description will be made that the display panel DP is an organic light emitting display panel, according to some embodiments.

The display panel DP includes first scan lines SL11 to SL1n, second scan lines SL21 to SL2n, data lines DL1 to DLm, pixels PX, and switching transistors ST1 to STn.

The display panel DP may be divided into a first display area DA1 and a second display area DA2. The first display area DA1 and the second display area DA2 may be sequentially arranged in the first direction DR1.

The first scan lines SL11 to SL1n are arranged in the first display area DA1, and the second scan lines SL21 to SL2n are arranged in the second display area DA2. Some of the data lines DL1 to DLm are arranged in the first display area DA1, and others are arranged in the second display area DA2. The data lines DL1 to DLm may include the first data lines DL1 to DLk and the second data lines DLk+1 to DLm. According to some embodiments, the first data lines DL1 to DLk may be arranged in the first display area DA1, and the second data lines DLk+1 to DLm may be arranged in the second display area DA2.

The first scan lines SL11 to SL1n may be connected to the first scan driving circuit SD1. The first scan lines SL11 to SL1n extend from the first scan driving circuit SD1 in the first direction DR1 and are arranged to be spaced apart from each other in a third direction DR3.

The second scan lines SL21 to SL2n may be connected to the second scan driving circuit SD2. The second scan lines SL21 to SL2n extend from the second scan driving circuit SD2 in the opposite direction of the first direction DR1, that is, a second direction DR2, and are arranged to be spaced apart from each other in the third direction DR3.

The data lines DL1 to DLm extend from the data driving circuit 200 in the third direction DR3, and are arranged to be spaced apart from each other in the first direction DR1.

The pixel PX arranged in the first display area DA1 is connected to the first scan line SL11 and the first data line DL1. The pixel PX arranged in the second display area DA2 is connected to the second scan line SL21 and the second data line DLk+1.

Although only one pixel PX is illustrated in each of the first display area DA1 and the second display area DA2 in FIG. 4, a plurality of pixels may be arranged in each of the first display area DA1 and the second display area DA2. Each of the plurality of pixels arranged in the first display area DA1 may be connected to at least one of the first scan lines SL11 to SL1n and at least one of the first data lines DL1 to DLk. Each of the plurality of pixels arranged in the second display area DA2 may be connected to at least one of the second scan lines SL21 to SL2n and at least one of the second data lines DLk+1 to DLm.

The data driving circuit 200 receives the data control signal DCS and the output image signal DATA from the driving controller 100. The data driving circuit 200 converts the output image signal DATA into data signals and outputs the data signals to the data lines DL1 to DLm.

The data driving circuit 200 may be implemented as an integrated circuit (IC) and may be directly mounted on an area (e.g., a set or predetermined area) of the display panel DP or may be mounted on a separate printed circuit board in a chip on film (COF) manner so as to be electrically connected to the display panel DP. According to some embodiments, the data driving circuit 200 may include the driving circuits DIC illustrated in FIG. 3.

The first scan driving circuit SD1 receives the first scan control signal SCS1 from the driving controller 100. The first scan driving circuit SD1 may output first scan signals to the first scan lines SL11 to SL1n in response to the first scan control signal SCS1. According to some embodiments, the first scan driving circuit SD1 may be formed in the same process as the pixel PX.

The second scan driving circuit SD2 receives the second scan control signal SCS2 from the driving controller 100. The second scan driving circuit SD2 may output second scan signals to the first scan lines SL11 to SL1n in response to the second scan control signal SCS2. According to some embodiments, the second scan driving circuit SD2 may be formed in the same process as the pixel PX.

According to some embodiments, the first scan signals output from the first scan driving circuit SD1 during the basic mode may be the same as the second scan signals output from the second scan driving circuit SD2. According to some embodiments, the first scan signals output from the first scan driving circuit SD1 during the artificial intelligence mode may be different from the second scan signals output from the second scan driving circuit SD2.

The switching transistors ST1 to STn connect the first scan lines SL11 to SL1n and the second scan lines SL21 to SL2n to each other in response to the switching signal AIG. For example, when the switching signal AIG is at a first level (a high level), the switching transistors ST1 to STn are turned on. As the switching transistors ST1 to STn are turned on, the first scan lines SL11 to SL1n and the second scan lines SL21 to SL2n may be connected to each other. As the switching signal AIG is at a second level (a low level), the switching transistors ST1 to STn are turned off. As the switching transistors ST1 to STn are turned off, the first scan lines SL11 to SL1n and the second scan lines SL21 to SL2n may be electrically separated from each other.

According to some embodiments, the driving controller 100 may output the switching signal AIG of the first level (the high level) when the mode signal MD indicates the basic mode. The driving controller 100 may output the switching signal AIG of the second level (the low level) when the mode signal MD indicates the artificial intelligence mode.

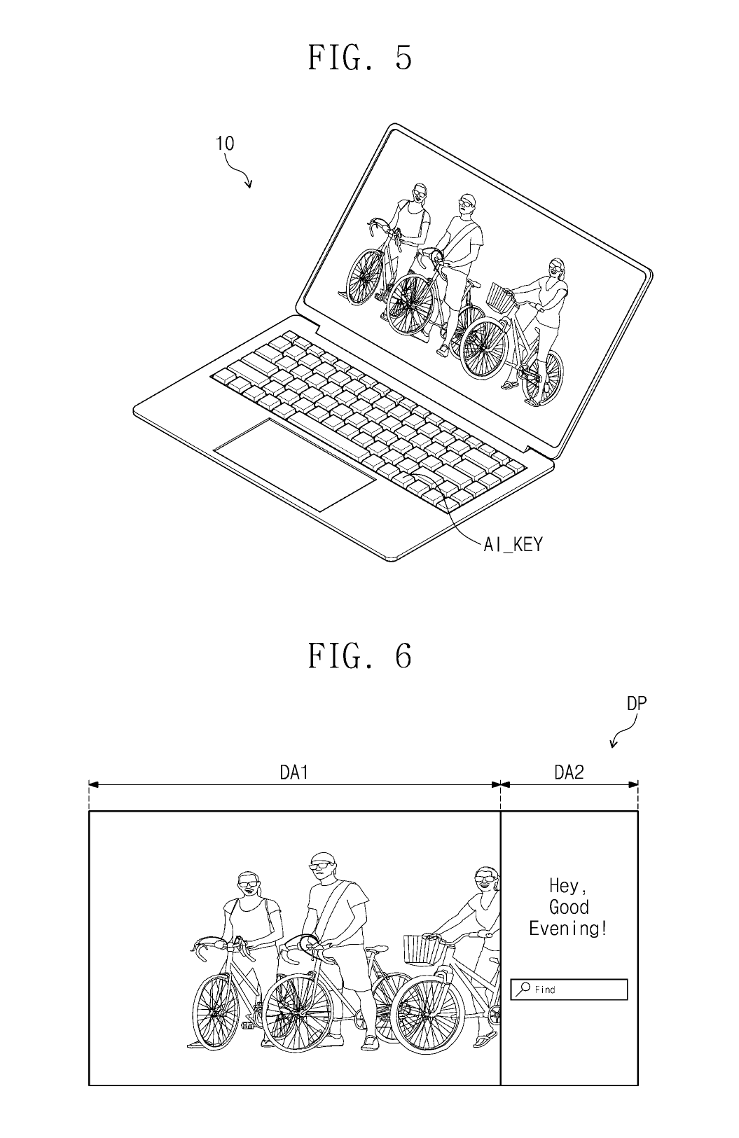

FIG. 5 is a perspective view illustrating the electronic device 10 according to some embodiments of the present disclosure.

Referring to FIGS. 4 and 5, the electronic device 10 includes a selection key AI_KEY that allows a user to select a function of an interactive artificial intelligence. When the user presses the selection key AI_KEY, the artificial intelligence signal AI_K may be provided to the processor PP. According to some embodiments, when a user selects the artificial intelligence mode using an application program, etc., the artificial intelligence signal AI_K may be provided to the processor PP.

FIG. 6 is a diagram illustrating an image displayed on the display panel DP in an artificial intelligence mode.

Referring to FIGS. 4 and 6, in the artificial intelligence mode, the display panel DP may be divided into the first display area DA1 and the second display area DA2. An image for the interactive artificial intelligence may be displayed on the second display area DA2. The image for the interactive artificial intelligence may be an image including text or a still image.

When a moving image is displayed on the first display area DA1 of the display panel DP, the first display area DA1 may be driven at a first frequency, and the second display area DA2 may be driven at a second frequency lower than the first frequency. By lowering the driving frequency of the second display area DA2 to the second frequency lower than the first frequency, the power consumed by the electronic device 10 (refer to FIG. 5) may be minimized or relatively reduced.

According to some embodiments, when a still or static image is displayed on the first display area DA1 of the display panel DP and a moving image is displayed on the second display area DA2, the first display area DA1 may be driven at the second frequency, and the second display area DA2 may be driven at the first frequency higher than the second frequency. By lowering the driving frequency of the first display area DA1 to the second frequency lower than the first frequency, the power consumed by the electronic device 10 (refer to FIG. 5) may be minimized or relatively reduced.

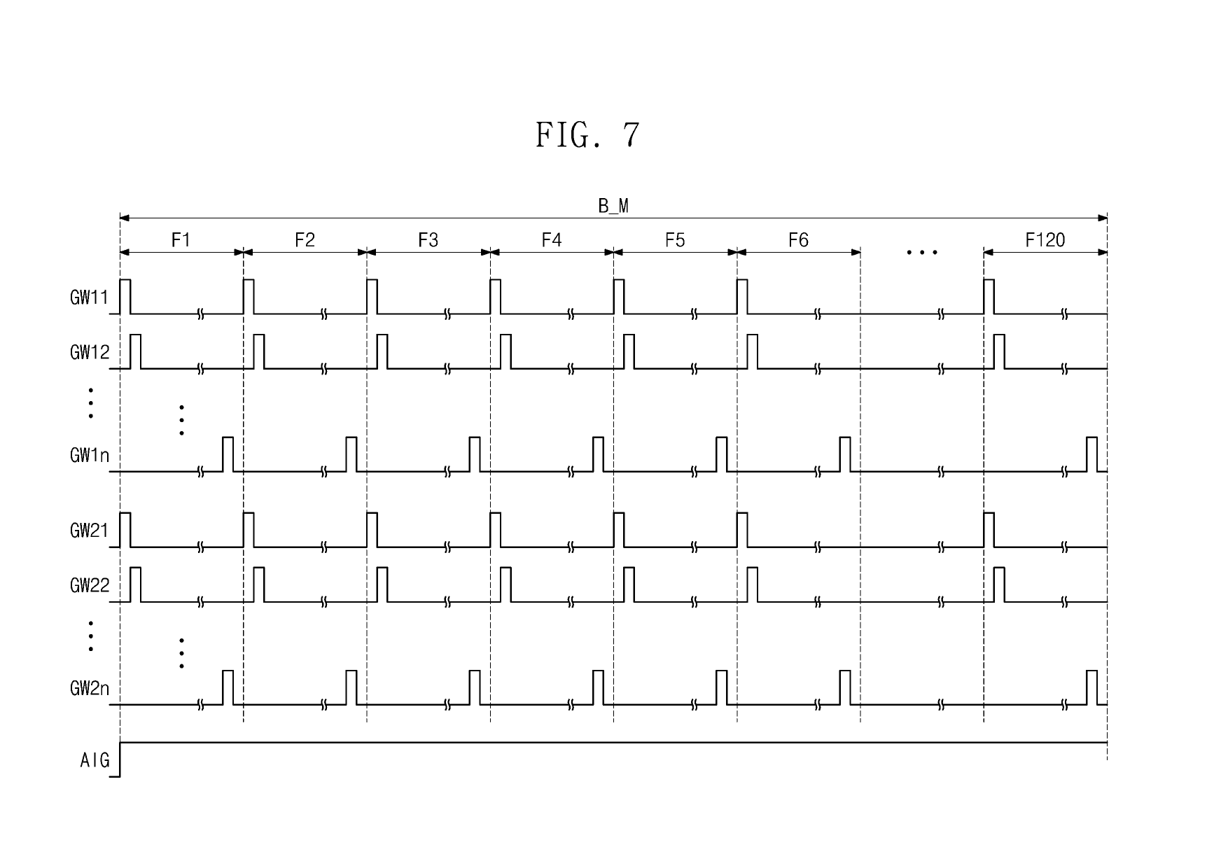

FIG. 7 is a diagram illustrating first scan signals GW11 to GW1n, second scan signals GW21 to GW2n, and the switching signal AIG in a basic mode B_M as an example.

Referring to FIG. 4 and FIG. 7, the first display area DA1 and the second display area DA2 of the display panel DP may be driven at the first frequency during the basic mode B_M. When the first frequency is 120Hz, the first scan signals GW11 to GW1n provided from the first scan driving circuit SD1 to the first scan lines SL11 to SL1n in each of first to 120th frames F1 to F120 may sequentially transition to an active level (e.g., a high level). In addition, the second scan signals GW21 to GW2n provided from the second scan driving circuit SD2 to the second scan lines SL21 to SL2n in each of the first to 120th frames F1 to F120 may sequentially transition to the active level (e.g., the high level).

During the basic mode B_M, the first scan signals GW11 to GW1n and the second scan signals GW21 to GW2n in each of the first to 120th frames F1 to F120 may be the same signal. For example, the first scan signal GW11 and the second scan signal GW21 are the same, the first scan signal GW12 and the second scan signal GW22 are the same, and the first scan signal GW1n and the second scan signal GW2n are the same.

During the basic mode B_M, the switching signal AIG is maintained at a first level (a high level). While the switching signal AIG is at the first level, the switching transistors ST1 to STn are turned on. As the switching transistors ST1 to STn are turned on, the first scan lines SL11 to SL1n and the second scan lines SL21 to SL2n may be connected to each other. Therefore, during the basic mode B_M, the first scan lines SL11 to SL1n and the second scan lines SL21 to SL2n may be commonly driven by the first scan signals GW11 to GW1n and the second scan signals GW21 to GW2n.

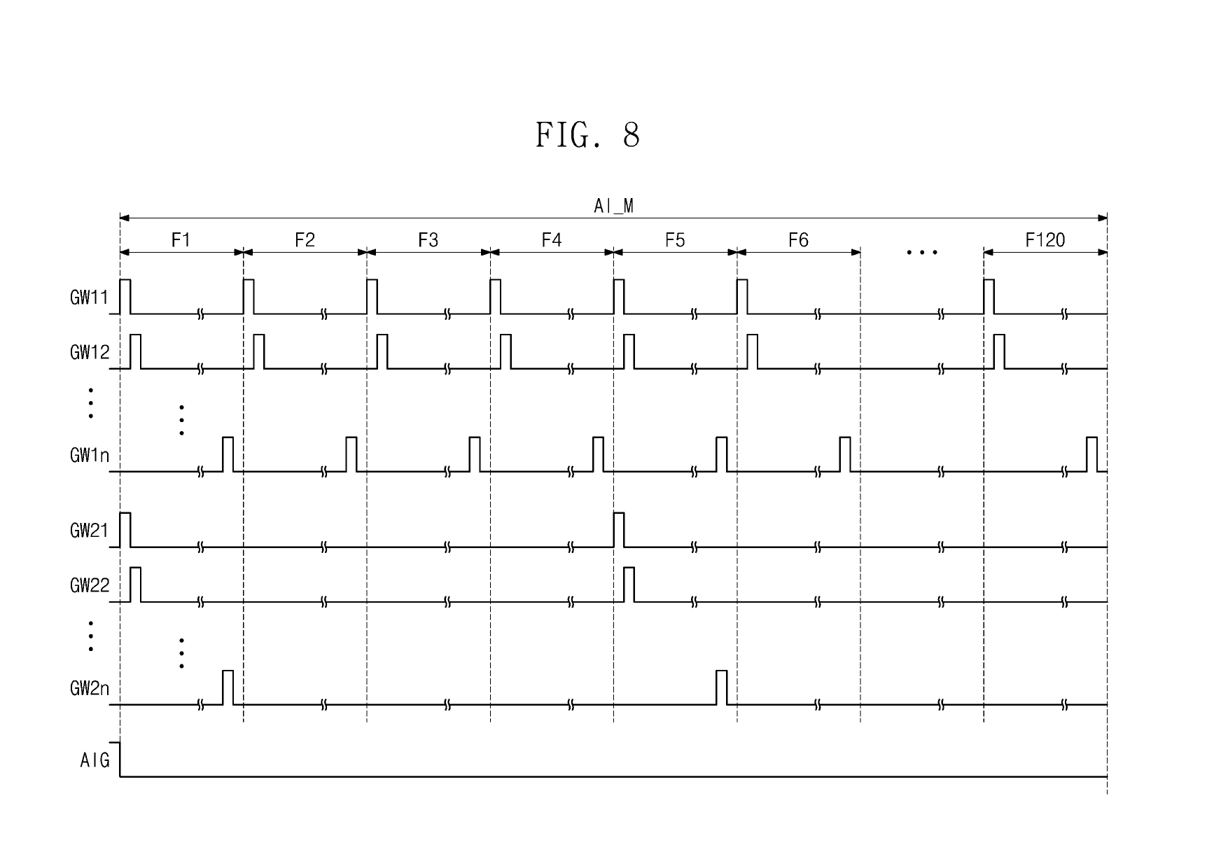

FIG. 8 is a diagram illustrating the first scan signals GW11 to GW1n, the second scan signals GW21 to GW2n, and the switching signal AIG in an artificial intelligence mode AI_M.

Referring to FIG. 4 and FIG. 8, during the artificial intelligence mode AI_M, the first display area DA1 of the display panel DP may be driven at a first frequency, and the second display area DA2 may be driven at a second frequency lower than the first frequency. According to some embodiments, the first frequency may be 120Hz, and the second frequency may be 30Hz.

The first scan signals GW11 to GW1n provided to the first scan lines SL11 to SL1n of the first display area DA1 may sequentially transition to an active level (e.g., a high level) in each of the first to 120th frames F1 to F120. In the example illustrated in FIG. 8, the driving frequency of the first scan signals GW11 to GW1n is 120Hz.

The second scan signals GW21 to GW2n provided to the second scan lines SL21 to SL2n of the second display area DA2 in some of the first to 120th frames F1 to F120, for example, in each of the first and fifth frames F1 and F5, may sequentially transition to the active level (e.g., the high level).

The second scan signals GW21 to GW2n provided to the second scan lines SL21 to SL2n of the second display area DA2 in some of the first to 120th frames F1 to F120, for example, in each of the second, third, fourth, sixth, and 120th frames F2, F3, F4, F6, and F120, may be maintained at an inactive level (e.g., a low level).

In each of the second, third, fourth, sixth, and 120th frames F2, F3, F4, F6, and F120, the pixel PX of the second display area DA2 may be maintained in a non-operating (or inactive) state as the second scan signals GW21 to GW2n are maintained at the inactive level. In the example illustrated in FIG. 8, the driving frequency of the second scan signals GW21 to GW2n is 30Hz.

During the artificial intelligence mode AI_M, the switching signal AIG is maintained at a second level (a low level). While the switching signal AIG is at the second level, the switching transistors ST1 to STn are turned off. As the switching transistors ST1 to STn are turned off, the first scan lines SL11 to SL1n and the second scan lines SL21 to SL2n may be electrically separated from each other. Therefore, during the artificial intelligence mode AI_M, the first scan lines SL11 to SL1n may be driven by the first scan signals GW11 to GW1n of 120Hz, and the second scan lines SL21 to SL2n may be driven by the second scan signals GW21 to GW2n of 30Hz. By lowering the second frequency of the second display area DA2 on which text information is displayed during the artificial intelligence mode AI_M than the first frequency of the first display area DA1, the power consumption of the electronic device 10 (refer to FIG. 5) may be relatively reduced.

During the artificial intelligence mode AI_M, when a still image is displayed in the first display area DA1 and a moving image is displayed in the second display area DA2, the first scan lines SL11 to SL1n may be driven by the first scan signals GW11 to GW1n of a second frequency (e.g., 30Hz), and the second scan lines SL21 to SL2n may be driven by the second scan signals GW21 to GW2n of a first frequency (e.g., 120Hz) higher than the second frequency. The power consumption of the electronic device 10 (refer to FIG. 5) may be relatively reduced by lowering the second frequency of the first display area DA1 on which text information is displayed during the artificial intelligence mode AI_M than the first frequency of the second display area DA2. During the artificial intelligence mode AI_M, the switching signal AIG is maintained at the second level (the low level) so that the switching transistors ST1 to STn are turned off. Therefore, the first display area DA1 and the second display area DA2 may be driven at different frequencies.

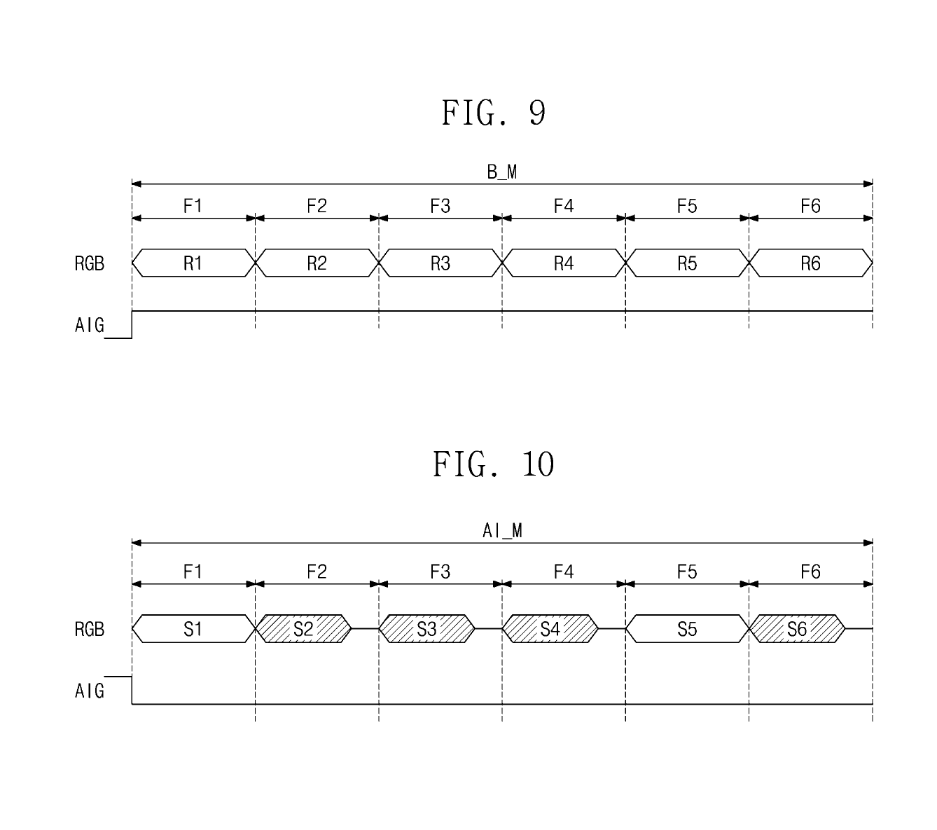

FIG. 9 is a diagram illustrating the image signal RGB and the switching signal AIG in the basic mode B_M as an example.

Referring to FIG. 4 and FIG. 9, during the basic mode B_M in which the switching signal AIG is maintained at the first level (the high level), both the first display area DA1 and the second display area DA2 of the display panel DP may be driven at the first frequency. During the basic mode B_M, the processor PP may provide the image signal RGB corresponding to both the first display area DA1 and the second display area DA2 of the display panel DP to the driving controller 100 of the display module DM.

The image signal RGB provided from the processor PP to the driving controller 100 in each of the first to sixth frames F1 to F6 of the basic mode B_M may include frame image signals R1, R2, R3, R4, R5, and R6. Each of the frame image signals R1, R2, R3, R4, R5, and R6 may correspond to both the first display area DA1 and the second display area DA2.

FIG. 10 is a diagram illustrating the image signal RGB and the switching signal AIG in the artificial intelligence mode AI_M as an example.

Referring to FIG. 4 and FIG. 10, during the artificial intelligence mode AI_M in which the switching signal AIG is maintained at the second level (the low level), the first display area DA1 of the display panel DP may be driven at the first frequency, and the second display area DA2 may be driven at the second frequency. During the artificial intelligence mode AI_M, the processor PP may provide the image signal RGB corresponding to both the first display area DA1 and the second display area DA2 or corresponding only to the first display area DA1 to the driving controller 100 of the display module DM.

The image signal RGB provided from the processor PP to the driving controller 100 in each of the first to sixth frames F1 to F6 of the artificial intelligence mode AI_M may include frame image signals S1, S2, S3, S4, S5, and S6. Each of the frame image signals S1 and S5 may correspond to both the first display area DA1 and the second display area DA2. Each of the frame image signals S2, S3, S4, and S6 may correspond to the first display area DA1.

According to some embodiments, the first data lines DL1 to DLk may be connected to the first to fourth driving circuits DIC1 to DIC4 illustrated in FIG. 3, and the second data lines DLk+1 to DLm may be connected to the fifth driving circuit DIC5.

Because the image signals corresponding to the fifth driving circuit DIC5 are not provided from the processor PP to the driving controller 100 in each of the second, third, fourth, and sixth frames F2, F3, F4, and F6 of the artificial intelligence mode AI_M, the fifth driving circuit DIC5 may be maintained in a non-operating state.

In detail, in each of the second, third, fourth, and sixth frames F2, F3, F4, and F6 of the artificial intelligence mode AI_M, the data driving circuit 200 outputs data signals to the first data lines DL1 to DLk and does not output data signals to the second data lines DLk+1 to DLm. Therefore, in the artificial intelligence mode AI_M, the power consumption of the fifth driving circuit DIC5 may be relatively reduced.

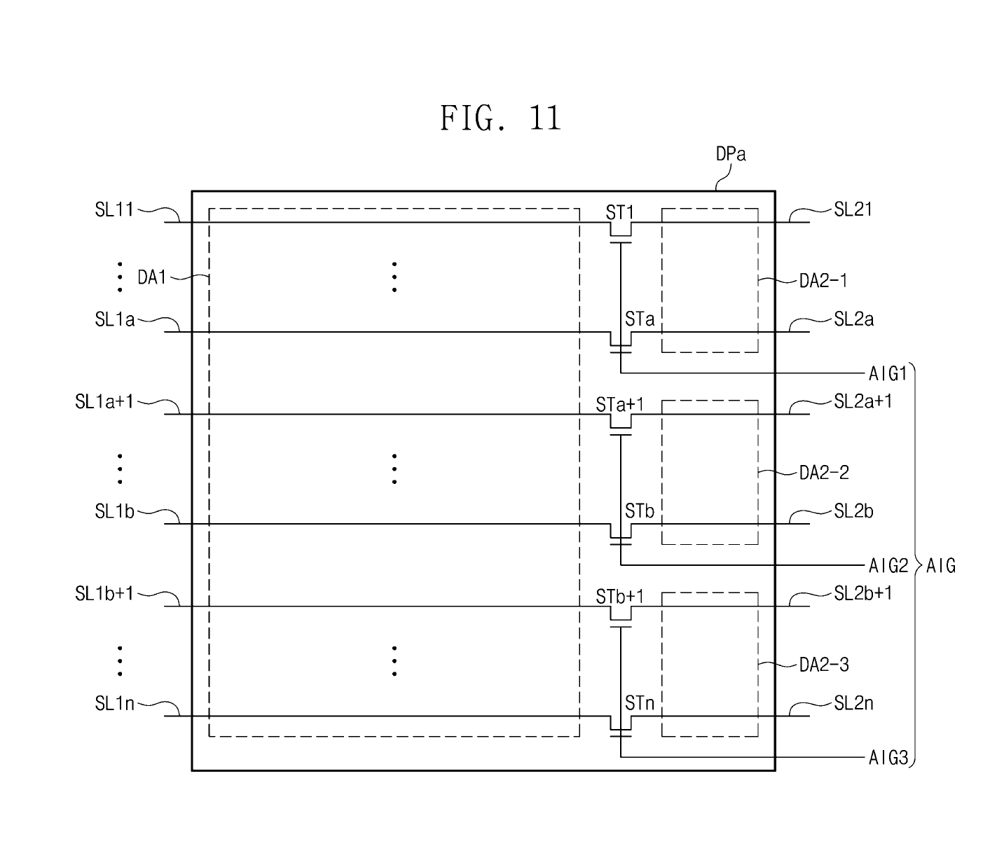

FIG. 11 is a diagram illustrating a display panel DPa, according to some embodiments of the present disclosure as an example.

Referring to FIG. 11, the display panel DPa may be divided into the first display area DA1, a 2-1 display area DA2-1, a 2-2 display area DA2-2, and a 2-3 display area DA2-3.

The display panel DPa includes the first scan lines SL11 to SL1n, the second scan lines SL21 to SL2n, and the switching transistors ST1 to STn.

The switching transistors ST1 to STa electrically connect the first scan lines SL11 to SL1a and the second scan lines SL21 to SL2a to each other in response to a first switching signal AIG1. The switching transistors STa+1 to STb electrically connect the first scan lines SL1a+1 to SL1b and the second scan lines SL2a+1 to SL2b to each other in response to a second switching signal AIG2. The switching transistors STb+1 to STn electrically connect the first scan lines SL1b+1 to SL1n and the second scan lines SL2b+1 to SL2n to each other in response to a third switching signal AIG3. The switching signal AIG provided from the driving controller 100 illustrated in FIG. 4 may include the first switching signal AIG1, the second switching signal AIG2, and the third switching signal AIG3.

During the basic mode, the first display area DA1 and the second display area DA2 of the display panel DP may be driven at a first frequency.

During the artificial intelligence mode AI_M, the first display area DA1 of the display panel DP may be driven at the first frequency, and each of the 2-1 display area DA2-1, the 2-2 display area DA2-2, and the 2-3 display area DA2-3 may be driven at the second frequency that is the same as or different from the first frequency. According to some embodiments, the first frequency may be 120Hz, and the second frequency may be 30Hz.

For example, when an image for interactive artificial intelligence is displayed on the 2-1 display area DA2-1, the switching transistors ST1 to STa may be turned off in response to the first switching signal AIG1, and the switching transistors STa+1 to STb and the switching transistors STb+1 to STn may be turned on in response to the second switching signal AIG2 and the third switching signal AIG3. Therefore, the first display area DA1, the 2-2 display area DA2-2, and the 2-3 display area DA2-3 may be driven at the first frequency, and the 2-1 display area DA2-1 may be driven at the second frequency.

The first display area DA1, the 2-1 display area DA2-1, the 2-2 display area DA2-2, and the 2-3 display area DA2-3 may be driven at an appropriate driving frequency depending on the characteristics (e.g., a moving image or a still image) of the image displayed thereon.

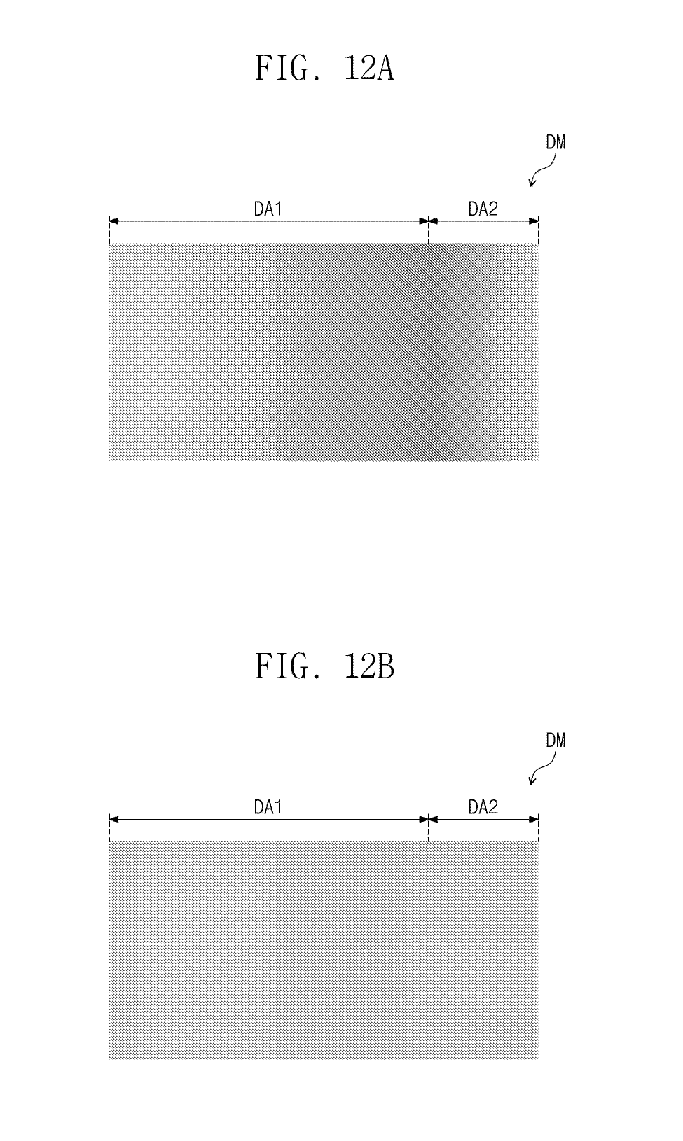

FIGS. 12A and 12B are diagrams illustrating images displayed on the display module DM as an example.

Referring to FIGS. 4 and 12A, according to some embodiments, the switching transistors ST1 to STn may always be turned off regardless of the operating mode. According to some embodiments, the display panel DP does not have the switching transistors ST1 to STn, and the first scan lines SL11 to SL1n and the second scan lines SL21 to SL2n may be electrically separated from each other.

In the example illustrated in FIG. 4, the length of the first direction DR1 of the first display area DA1 and the length of the second direction DR2 of the second display area DA2 are different from each other. That is, the length of the first direction DR1 of the first scan lines SL11 to SL1n arranged in the first display area DA1 and the length of the second direction DR2 of the second scan lines SL21 to SL2n arranged in the second display area DA2 are different from each other. Therefore, the RC delay of the first scan lines SL11 to SL1n and the RC delay of the second scan lines SL21 to SL2n may be different from each other.

In this case, after an image is displayed on the display module DM for a long time, the brightness of the boundary portion where the first display area DA1 and the second display area DA2 meet may be different from other portions.

Referring to FIGS. 4, 7, and 12B, the switching transistors ST1 to STn are turned on during the basic mode. Therefore, the first scan lines SL11 to SL1n and the second scan lines SL21 to SL2n may be commonly driven by the first scan signals GW11 to GW1n and the second scan signals GW21 to GW2n.

Referring to FIGS. 4, 8, and 12B, during the artificial intelligence mode AI_M, the switching transistors ST1 to STn are turned off so that the first scan lines SL11 to SL1n may be driven by the first scan signals GW11 to GW1n, and the second scan lines SL21 to SL2n may be driven by the second scan signals GW21 to GW2n.

Depending on the operation mode, by connecting/disconnecting the first scan lines SL11 to SL1n and the second scan lines SL21 to SL2n, the brightness of the boundary portion where the first display area DA1 and the second display area DA2 meet may be the same as that of other portions.

According to some embodiments of the present disclosure, an electronic device having such a configuration may lower the driving frequency of the image display area for interactive artificial intelligence below the basic frequency. Therefore, the power consumption of the electronic device may be relatively reduced.

Although the present disclosure has been described above with reference to embodiments thereof, it will be understood by those skilled in the art or having ordinary knowledge in the art that various modifications, and substitutions are possible, without departing from the spirit and the technical scope of the present disclosure as set forth in the claims below. Accordingly, the technical scope of embodiments according to the present disclosure is not limited to the detailed description of this specification, but should be defined by the claims, and their equivalents.

What is claimed is:

1. An electronic device comprising:
a processor configured to output an image signal, a control signal, and a mode signal; and
a display module configured to display an image, and
wherein the display module includes:
a display panel divided into a first display area and a second display area, and including first scan lines in the first display area, second scan lines in the second display area, and switching transistors configured to electrically connect the first scan lines and the second scan lines in response to a switching signal;
a first scan driving circuit configured to output first scan signals to the first scan lines;
a second scan driving circuit configured to output second scan signals to the second scan lines;
a data driving circuit configured to output data signals to the display module; and
a driving controller configured to control the first scan driving circuit, the second scan driving circuit, and the data driving circuit in response to the image signal, the control signal, and the mode signal, and
wherein the driving controller outputs the switching signal such that the first scan lines and the second scan lines are electrically separated based on the mode signal indicating an artificial intelligence mode for displaying an artificial intelligence image.

2. The electronic device of claim 1, wherein each of the first scan lines extends in a first direction from the first scan driving circuit,
wherein each of the second scan lines extends in a second direction different from the first direction from the second scan driving circuit, and
wherein the first display area and the second display area are sequentially arranged in the first direction.

3. The electronic device of claim 2, wherein during the artificial intelligence mode, the first display area is driven at a first frequency, and the second display area is driven at a second frequency different from the first frequency.

4. The electronic device of claim 3, wherein during the artificial intelligence mode, the first scan driving circuit is configured to output the first scan signals having the first frequency, and the second scan driving circuit is configured to output the second scan signals having the second frequency.

5. The electronic device of claim 4, wherein the artificial intelligence image includes a still image, and
wherein the second frequency is lower than the first frequency.

6. The electronic device of claim 4, wherein the display panel further includes first data lines arranged in the first display area and second data lines arranged in the second display area.

7. The electronic device of claim 6, wherein during a first frame of the artificial intelligence mode, the data driving circuit is configured to output the data signals to the first data lines and the second data lines, and
wherein during a second frame of the artificial intelligence mode, the data driving circuit is configured to output the data signals to the first data lines and is configured to not output the data signals to the second data lines.

8. The electronic device of claim 3, wherein the driving controller outputs the switching signal such that the first scan lines and the second scan lines are electrically connected when the mode signal indicates a basic mode different from the artificial intelligence mode.

9. The electronic device of claim 8, wherein during the basic mode, both the first display area and the second display area are configured to be driven at the first frequency.

10. The electronic device of claim 1, wherein the processor is configured to output the image signal corresponding to the first display area and the second display area during a first frame of the artificial intelligence mode, and
wherein the processor is configured to output the image signal corresponding to the first display area during a second frame of the artificial intelligence mode.

11. The electronic device of claim 1, wherein based on the artificial intelligence mode being selected by a user, an artificial intelligence signal indicating the artificial intelligence mode is provided to the processor, and
wherein the processor outputs the mode signal in response to the artificial intelligence signal.

12. An electronic device comprising:
a display panel divided into a first display area and a second display area, and including first scan lines in the first display area, second scan lines in the second display area, and switching transistors configured to electrically connect the first scan lines and the second scan lines in response to a switching signal;
a first scan driving circuit configured to output first scan signals to the first scan lines;
a second scan driving circuit configured to output second scan signals to the second scan lines;
a data driving circuit configured to output data signals to the display panel; and
a driving controller configured to control the first scan driving circuit, the second scan driving circuit, and the data driving circuit in response to an image signal, a control signal, and a mode signal, and
wherein the driving controller is configured to output the switching signal such that the first scan lines and the second scan lines are electrically separated based on the mode signal indicating an artificial intelligence mode for displaying an artificial intelligence image, and
wherein, during the artificial intelligence mode, the first display area is configured to be driven at a first frequency, and the second display area is configured to be driven at a second frequency different from the first frequency.

13. The electronic device of claim 12, wherein each of the first scan lines extends in a first direction from the first scan driving circuit,
wherein each of the second scan lines extends in a second direction different from the first direction from the second scan driving circuit, and
wherein the first display area and the second display area are sequentially arranged in the first direction.

14. The electronic device of claim 12, wherein during the artificial intelligence mode, the first scan driving circuit is configured to output the first scan signals having the first frequency, and the second scan driving circuit is configured to output the second scan signals having the second frequency.

15. The electronic device of claim 14, wherein the artificial intelligence image includes a still image, and
wherein the second frequency is lower than the first frequency.

16. The electronic device of claim 14, wherein the display panel further includes first data lines in the first display area and second data lines in the second display area.

17. The electronic device of claim 16, wherein during a first frame of the artificial intelligence mode, the data driving circuit is configured to output the data signals to the first data lines and the second data lines, and
wherein during a second frame of the artificial intelligence mode, the data driving circuit is configured to output the data signals to the first data lines and to not output the data signals to the second data lines.

18. The electronic device of claim 12, wherein the driving controller is configured to output the switching signal such that the first scan lines and the second scan lines are electrically connected based on the mode signal indicating a basic mode different from the artificial intelligence mode.

19. The electronic device of claim 18, wherein during the basic mode, both the first display area and the second display area are configured to be driven at the first frequency.

20. The electronic device of claim 12, wherein during the artificial intelligence mode, a moving image is displayed in the first display area, and a still image is displayed in the second display area.
